(19) United States
(12) Patent Application Publication
(10) Pub. No.: US 2012/0026282 A1
(43) Pub. Date: Feb. 2, 2012

(54) CAMERA

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/946,974

(22) Filed: Nov. 16, 2010

(30) Foreign Application Priority Data
Jul. 27, 2010 (TW) 99124626

(51) Int. Cl. H04N 5/225

(52) U.S. Cl. 348/36; 348/218.1; 348/E05.024

(57) ABSTRACT

A camera includes a plurality of image capturing unit, a switch unit, and a processor unit. Each image capturing unit includes a lens capturing images and an image sensor transforming optical signals of the images captured by the lens into electric signals. The switch unit is electrically connected to all the image sensors. The processor unit is electrically connected to the switch unit. The image sensors of all the image capturing units are alternately connected to the processor unit to alternately transmit the electric signals generated by the image capturing units to the processor unit, and the processor unit transforms the electric signals into images respectively captured by all the image capturing units and combines the images together to form multiple images cooperatively captured by all the image capturing units.

### BACKGROUND

1. Technical Field

The present disclosure relates to cameras, and particularly to a panoramic camera.

2. Description of Related Art

Panoramic cameras are widely used. Generally, a conventional panoramic camera includes a rotary device capable of rotating 360 degrees, and an image capturing apparatus of the camera assembled to the rotary device. In use, the rotary device and the image capturing apparatus are driven to automatically rotate (e.g., by a motor) 360 degrees, such that panoramic images around the camera are captured by the image capturing apparatus. However, most rotary devices used in panoramic cameras are expensive and have complicated structures, which may adversely affect miniaturization of the cameras.

Therefore, there is room for improvement within the art.

### BRIEF DESCRIPTION OF THE DRAWINGS

Many aspects of the present panoramic camera can be better understood with reference to the following drawings. The components in the various drawings are not necessarily drawn to scale, the emphasis instead being placed upon clearly illustrating the principles of the present panoramic camera. Moreover, in the drawings, like reference numerals designate corresponding parts throughout the figures.

FIG. 1 is a block diagram of a camera, according to an exemplary embodiment.

FIG. 2 is a block diagram of an internet protocol (IP) camera system using the camera shown in FIG. 1.

### DETAILED DESCRIPTION

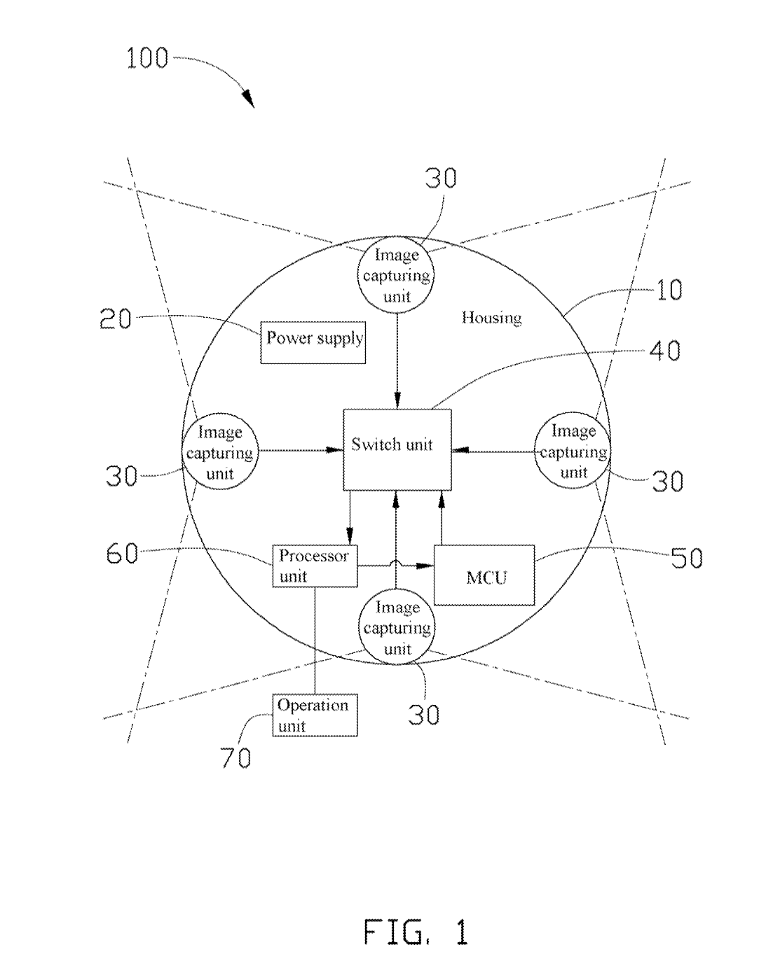

FIG. 1 shows a panoramic camera 100, according to an exemplary embodiment. The camera 100 includes a housing 10 (schematically shown), a power supply 20, a number of image capturing units 30, a switch unit 40, a microprogrammed control unit (MCU) 50, a processor unit 60, and an operation unit 70. The housing 10 is a spherical case made of transparent material. The image capturing units 30 are all received in the housing 10 and positioned to face outwards to capture ambient images. In this exemplary embodiment, the camera 100 includes four image capturing units 30. The image capturing units 30 are equidistantly positioned along a circle of the housing 10, and image capturing directions of all the image capturing units 30 are positioned coplanar, and advantageously, positioned flatly. Each image capturing unit 30 is capable of capturing images in a visual angle greater than 90 degrees, such that a total visual angle of all the image capturing units 30 covers 360 degrees. Therefore, the four image capturing units 30 can cooperatively capture images in a visual angle of 360 degrees, i.e., panoramic images around the housing 10. The power supply 20, the switch unit 40, the MCU 50, and the processor unit 60 can also be received in the housing 10. The operation unit 70 is positioned out of the housing 10 to be easily operated.

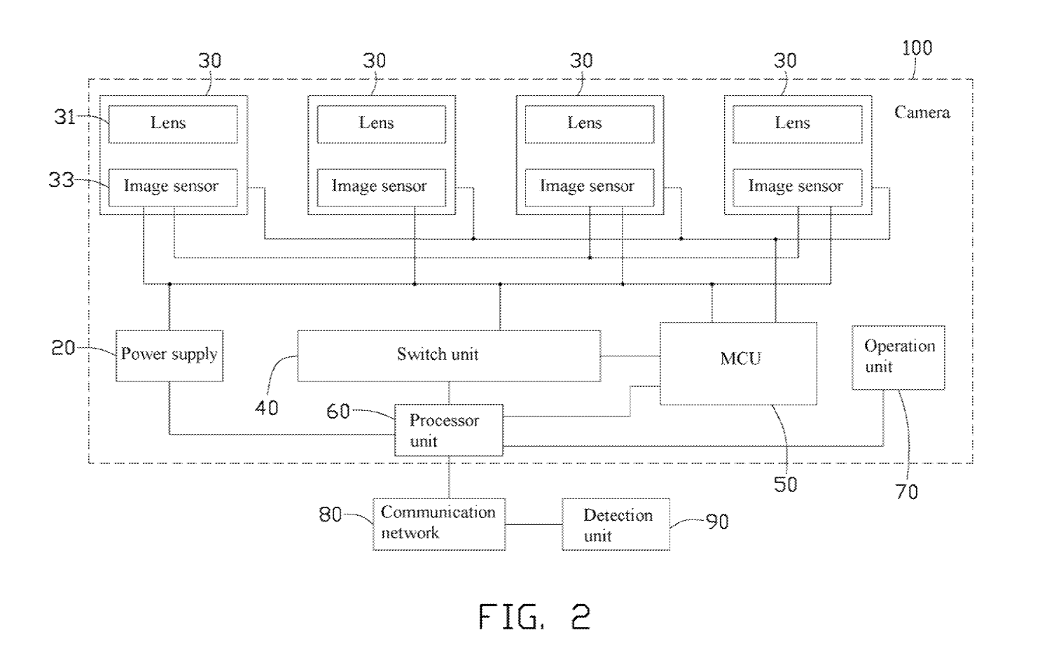

Also referring to FIG. 2, each image capturing unit 30 is a digital camera module that includes a lens 31 and an image sensor 33 positioned in a light emitting path of the lens 31. The lens 31 is capable of capturing images in a view angle greater than 90 degrees. Optical signals of images captured by the lenses 31 can be transmitted to the image sensors 33 and transformed into electric signals by the image sensors 33. All image sensors 33 are electrically connected to the processor unit 60 through the switch unit 40. The switch unit 40 can electrically connect any one of the image sensors 33 selectively to the processor unit 60, such that electric signals generated by the selected image sensor 33 are transmitted to the processor unit 60 via the switch unit 40.

The processor unit 60 is further electrically connected to the switch unit 40 and all the image capturing units 30 through the MCU 50. Using the MCU 50, the processor unit 60 can control the image capturing units 30 to start/end capturing images and control the switch unit 40 to selectively connect the image sensors 30 to the processor unit 60 itself, and can further alternate the image sensor 30 connected thereto in a predetermined frequency. The operation unit 70 is electrically connected to the processor unit 60 to input instructions and set relative function parameters. The power supply 20 is electrically connected to the processor unit 60 and the MCU 50 to provide electric power.

In use, relative function parameters, such as image capturing parameters of the image capturing units 30 (e.g., focus, aperture diameter, image capturing interval, etc.), the frequency of alternating the image sensors 33 connected to the processor unit 60, and image parameters of images sent by the processor unit 60 (e.g., colors, definition, etc.), are first input to the processor unit 60 using the operation unit 70 and are stored in the processor unit 60. Thus, the processor unit 60 controls the image capturing units 30 to respectively start capturing images in each direction using the MCU 50. Since each image capturing unit 30 has an image capturing view angle greater than 90 degrees, images in a visual angle of 360 degrees, i.e., panoramic images around the camera 100, are captured by the combined image capturing units 30. The image sensor 33 of each image capturing unit 30 transforms optical signals captured by the lens 31 into electric signals.

When receiving a panoramic capturing instruction input by the operation unit 70, the processor unit 60 sends control instructions to the MCU 50, and the MCU 50 drives the switch unit 40 to alternately electrically connect each image sensor 33 to the processor unit 60 in a predetermined frequency according to the control instructions. In this way, electric signals respectively generated by the image capturing units 30 are alternatively transmitted to the processor unit 60 in the predetermined frequency with the switch unit 40. The processor unit 60 transforms the electric signals into images respectively captured in each direction by the image capturing units 30, and combines the images captured by the image capturing units 30 together to form multiple images cooperatively captured by all the image capturing units 30. Since each image capturing unit 30 has an image capturing view angle greater than 90 degrees, the combined multiple images can display images in a visual angle of 360 degrees around the camera 100, i.e., panoramic images. In this way, the camera 100 can capture panoramic images, without using any rotary apparatuses. Compared with conventional panoramic cameras using rotary lenses, the camera 100 has a simpler structure and costs less.

Also referring to FIG. 2, the processor unit 60 can be connected to at least one detection unit 90, such as a personal computer (PC), by a communication network 80, such as Internet, thereby forming a internet protocol (IP) camera system (not labeled). Thus, the processor unit 60 can transmit captured panoramic images to the detection unit 90 to display by the communication network, thereby using the camera 100 as an IP camera. In this status, operation instructions can also input to the processor unit 60 through the detection unit 90 and the communication network 80, thereby remotely operating the camera 100.

For obtaining panoramic image capturing effect similar to that of conventional panoramic cameras using rotary lenses, the frequency of alternating the image sensors 33 connected to the processor unit 60 can be set according to rotation periods of lenses of the conventional panoramic cameras. For example, the frequency of alternating the image sensor 33 connected to the processor unit 60 can be 4 times in each rotation period of a lens of a conventional panoramic camera (i.e., the interval for the lens of the conventional panoramic camera rotating a circle). Thus, the image capturing units 30 respectively capture images in their directions in the interval for the lens of the conventional panoramic camera rotating along a circle, and the image capturing units 30 can cooperatively capture images similar to images captured by a lens of a conventional camera rotating along a circle. In this way, the camera 100 can capture images similar to the images captured by conventional panoramic cameras using rotary lenses.

Furthermore, the MCU 50 can also be integrated with the processor unit 60. The number of the image capturing units 30 can be changed, so long as a total visual angle of all the image capturing units 30 covers 360 degrees. Correspondingly, the frequency of alternating the image sensors 33 connected to the processor unit 60 can be regulated for obtaining panoramic image capturing effect similar to that of conventional panoramic cameras using rotary lenses. For example, the frequency of alternating the image sensor 33 connected to the processor unit 60 can be N times in each rotation period of a lens of a conventional panoramic camera (i.e., the interval for the lens of the conventional panoramic camera rotating a circle). Wherein N is the number of the image capturing units 30 capable of being electrically connected to the processor unit 60 with the switch unit 40.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A camera, comprising:
a plurality of image capturing unit, each image capturing unit including a lens capturing images and an image sensor transforming optical signals of the images captured by the lens into electric signals;
a switch unit electrically connected to all the image sensors;
a processor unit electrically connected to the switch unit; wherein the image sensors of all the image capturing units are alternately connected to the processor unit to alternately transmit the electric signals generated by the image capturing units to the processor unit, and the processor unit transforms the electric signals into images respectively captured by all the image capturing units and combines the images together to form multiple images cooperatively captured by all the image capturing units.

2. The camera as claimed in claim 1, wherein the image sensors of all the image capturing units are alternately connected to the processor unit in a predetermined frequency to alternately transmit the electric signals generated by the image capturing units to the processor unit in the predetermined frequency.

3. The camera as claimed in claim 2, wherein all the image capturing units are positioned to face outwards along a circle, and image capturing directions of all the image capturing units are coplanar.

4. The camera as claimed in claim 3, wherein a total visual angle of all the image capturing units covers 360 degrees, such that all the image capturing units cooperatively capture panoramic images around the housing and the multiple images generated by the processor unit displays the panoramic images.

5. The camera as claimed in claim 1, further comprising a microprogrammed control unit (MCU) electrically connected to the processor unit and the switch unit, the processor unit controlling the switch unit to selectively connect the image sensors to the processor unit itself and alternate the image sensor connected thereto using the MCU.

6. The camera as claimed in claim 5, wherein the MCU is further electrically connected to all the image capturing units, and the processor unit controls all the image capturing units to start/end capturing images using the MCU.

7. The camera as claimed in claim 1, further comprising a spherical housing, wherein all the image capturing units are equidistantly positioned to face outwards along a circle of the housing.

8. The camera as claimed in claim 7, wherein the housing is transparent.

9. The camera as claimed in claim 1, further comprising an operation unit electronically connected to the processor unit for inputting instructions and setting functioning parameters.

10. The camera as claimed in claim 1, wherein the camera is remotely operated by a detection unit connected to the processor unit through a communication network.
